(19) United States
(12) Patent Application Publication
(10) Pub. No.: US 2016/0018015 A1
(43) Pub. Date: Jan. 21, 2016

(54) Piston Valve Having Piston with Grooves for Particulate Capture

(71) Applicants: George A. Holmes, West Chicago, IL (US); Tadeuz Rybka, Streamwood, IL (US)

(72) Inventors: George A. Holmes, West Chicago, IL (US); Tadeuz Rybka, Streamwood, IL (US)

(21) Appl. No.: 14/696,240

(22) Filed: Apr. 24, 2015

Related U.S. Application Data
(63) Continuation of application No. 13/147,523, filed on Dec. 22, 2011, now abandoned.

(51) Int. Cl. F16K 27/02; B01D 35/28; B01D 35/02; F16K 11/04

(52) U.S. Cl. CPC F16K 27/0263; F16K 11/04; B01D 35/28; B01D 35/02

(57) ABSTRACT

A diverter valve for use with fluids containing particulate matter is presented. The diverter valve includes a piston slidable between a first and second position in a valve casing. In the first position, a pass-through transverse bore in the piston is aligned with openings in the valve casing to allow a fluid to pass through to a first conduit. In a second piston position, a port for a diverter bore in the piston is aligned with an opening in the valve casing such that the fluid is diverted away from the first conduit. The piston includes a plurality of grooves structured to capture fluid and particulate matter that enters the slight gap between the piston and the valve casing.

### FIELD OF THE INVENTION

This invention pertains to valves and, more particularly, piston valves.

### BACKGROUND OF THE INVENTION

Piston valves are commonly used for a variety of industrial applications. Piston valves typically operate through the movement of a piston within a cylinder formed within the valve body to control the flow of fluid through the valve. In some industrial applications, such as plastic extrusion, the fluid may contain particulate that can become trapped between the valve cylinder wall and the piston causing the piston to jam.

### BRIEF SUMMARY OF THE INVENTION

In one exemplary embodiment of the present invention, a piston valve is shown having formed therein a valve cylinder. The valve includes a piston disposed within the valve cylinder, where the piston has formed therein a plurality of annular grooves for capturing particulate.

### BRIEF DESCRIPTION OF THE DRAWINGS

Certain aspects of the present invention will be described with reference to the following drawings, wherein:

FIG. 1 is a schematic drawing illustrating a front view of an exemplary embodiment of a diverter valve in accordance with the present invention;

FIG. 2 is a schematic drawing illustrating a side view of the diverter valve of FIG. 1; and

FIG. 3 is a schematic drawing illustrating a side view of an exemplary embodiment of a diverter piston for the diverter valve of FIG. 1, the diverter piston featuring multiple annular grooves for capturing particulate during the operation of the diverter valve.

FIG. 4 is a cross-sectional view of the diverter piston illustrated in FIG. 3.

### DETAILED DESCRIPTION

Piston valves are sometimes used in applications involving the control of fluid flow, where the fluid may contain particulate contamination. To avoid leakage, the space between the piston and the valve cylinder wall is typically extremely small. The plurality of particles may become lodged between the piston and the valve cylinder wall causing friction between the piston and the valve cylinder that impedes movement of the piston. In other words, the piston may become jammed due to the particulate contamination. In addition, the fluid itself may work its way into the small space between the piston and the cylinder wall and impede movement of the piston.

For example, in underwater pelletizer applications, molten plastic is typically extruded through a die face where it is cut into a stream of liquid to form pellets. It is desirable to maintain a constant flow of molten plastic through the plastic extrusion machinery. However, it is also desirable to access the die face of the underwater pelletizer, which, if the flow of molten plastic is not stopped, results in the accumulation of agglomerated plastic material, which may impact the operation of the pelletizer. A piston based diverter valve may be employed to divert the stream of molten plastic from the die face when desired, such as during start-up or clean-out operations on the pelletizer.

The molten plastic may contain particulate, such as wood fibers, due to the contamination or due to inclusion in the desired plastic material. As the piston moves within the valve cylinder, the particulate, e.g. dust, becomes lodged in between the piston and the cylinder wall and impedes movement of the piston. Further, the plastic material may also accumulate in between the piston and the cylinder wall, which may also impeded movement of the piston, particularly if the plastic solidifies.

In one embodiment of the present invention, a piston valve has a jamming resistant piston and a valve body having a valve cylinder formed therein for receiving the piston. The piston has multiple annular rings formed on an outer/exterior surface of the piston that circumscribes the piston and is configured to generally contact or be adjacent to a wall or interior surface of the valve cylinder or valve casing. The interior surface of the valve casing also circumscribes a section of the jamming resistant piston. The annular rings are configured to capture or trap fluid, particulates, and other material that may be introduced between the outer/exterior surface of the piston and the wall/interior surface of the valve cylinder/casing.

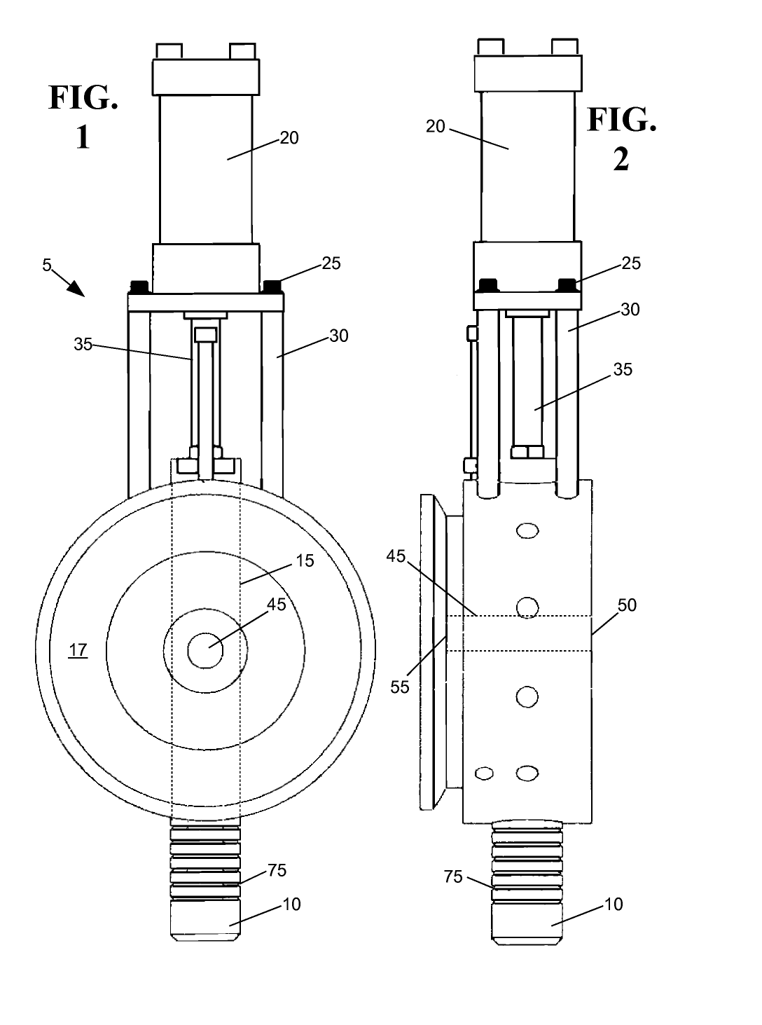

One exemplary embodiment of piston valve according to the present invention is the piston diverter valve shown in FIGS. 1-3. FIGS. 1 and 2 are schematic drawings illustrating front and side views, respectively, of an exemplary embodiment of a diverter valve 5 having a cylindrical diverter piston 10 that fits into a corresponding valve cylinder 15 formed in a body 17 of the diverter valve. In this example, a hydraulic cylinder 20 is rigidly secured to the valve casing through a shoulder bolt 25 and cylinder support bar 30. An actuation piston 35 or actuator extends from the hydraulic cylinder and connects to a first end of the diverter piston for axially sliding the jam resistant piston through the valve casing.

The hydraulic cylinder is used to axially actuate the diverter piston to move between two positions in this embodiment: a first position associated with fluid through flow and a second position associated with flow diversion. The diverter piston has a transverse bore 40 formed therein that corresponds to a central bore 45 formed in the diverter body for the purpose of fluid flow through the diverter body 17 when the diverter piston is in the first position associated with fluid through flow. The diverter piston is positioned to bisect the central bore of the diverter body so that fluid flows from a first opening 50 of the central bore to an outlet port on the interior surface of the valve casing, to a pass-though inlet port on the jam resistant piston, through the transverse bore or fluid channel of the diverter piston to a pass-though outlet, to a second opening 55 of the central bore when the diverter piston is in the first position. In one embodiment, the transverse bore extends though the piston perpendicular to the axis of the piston.

The diverter piston also has an diversion fluid channel or axial bore 60 formed therein that includes a radially formed diversion port opening 65 for communication with the first opening of the central bore or diverter channel of the diverter body and an external discharge port opening 70. When the diverter piston is in the second position, fluid flows from the first opening of the central bore into the diversion port opening 65, through the axial bore 60 of the piston, to the discharge port opening 70.

During typical operation of the diverter valve, the diverter piston is moved to the first position to permit the flow of material through the diverter body. The diverter piston is moved to the second position to divert the flow of material to the discharge port. Repeated axial movement of the diverter piston between the first and second positions may result, for example, in particulate or solidified plastic becoming lodged in between an outer surface of the diverter piston and the valve cylinder wall. Repeated axial movement of the jamming resistant piston moves the particulates and fluid located between the exterior surface of the piston and the interior surface of the casing such that a portion of the contaminant particles become sequestered within the grooves on the exterior surface of the piston. A conventional diverter piston often becomes quickly jammed during operation.

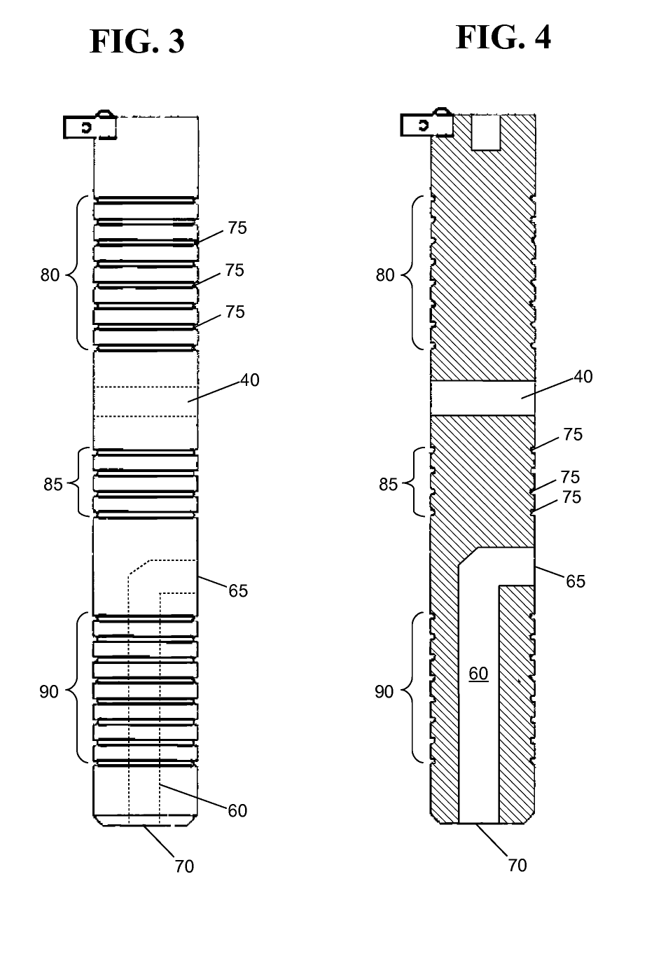

FIG. 3 is a schematic diagram illustrating an example of a diverter piston according to the present invention. The diverter piston has formed in its outer surface, e.g. the surface that generally comes in contact with the valve cylinder wall, a series of annular grooves 75. In this example, the grooves are formed on the outer surface of the diverter piston adjacent to the openings for the transverse bore and the diverter port. The exterior surface includes a first set of grooves 80 circumscribing a portion/section of the piston between the pass-through channel/transverse bore 40 and the actuation piston 35. A second set 85 of grooves circumscribes a portion/section of the piston located between the pass-through channel/transverse bore 40 and the radially formed diversion port opening 65. A third set 90 of annular grooves circumscribes a portion/section of the piston located between the radially formed diversion port opening 65 and the external discharge port opening 70. In the illustrated example, the diversion port opening 65 has the same diameter and perimeter as the pass-through inlet of the transverse bore 40. Additionally, the outlet port on the interior surface of the valve casing has cooperates with, and has the same perimeter/diameter as the diversion port opening 65 and the pass-through inlet of the transverse bore 40.

The external discharge port opening 70 is located at first end of the piston while the actuation piston 35 is secured at a second end of the piston. The first set of grooves 80 is separated from both the second set of grooves 85 and the third set of grooves 90 by the pass-though inlet port of the pass-through channel/transverse bore 40. In the example shown in FIGS. 3 and 4, the entirely of the transverse bores is located between the first and second set of grooves. The pass-through inlet is also distant from both the first and second set of grooves. The second set of grooves 85 is separated from the third set of grooves 90 by diversion port opening 65 of the diverter channel. The diversion port opening 65 is located distant from the first, second, and third set of grooves. As shown in FIGS. 3 and 4, each of groove in the first set of grooves is parallel to each of the grooves in the second and third set of grooves. Each groove fully circumscribes the jamming resistant piston.

During operation, when the diverter piston is generally moved axially between the first and second positions, some particulate that enters between the outer surface of the diverter piston and the valve cylinder wall is captured in the annular grooves when the diverter piston moves. Similarly, solidified plastic or other materials that may be introduced between the diverter piston and the cylinder wall will also tend to accumulate in the grooves. The piston with grooves on its outer surface for particulate capture tends to allow the valve to operate without impairment for longer operational periods compared to conventional pistons.

Note that while the piston and valve cylinder are described in the exemplary embodiment as substantially cylindrical in shape and the grooves, therefore, described as being annular, other shapes may be utilized without departing from the scope of the invention. For example, the piston and valve cylinder may be constructed with a rectangular or polygonal cross section, in which case the grooves would still be formed on the outer surface of the piston, but would not be annular. The grooves in such an embodiment would still function to capture particulate and other matter introduced between the piston and the valve cylinder wall.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and docs not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1. A valve for selectively diverting a fluid carrying a plurality of particulates the valve
comprising:
a jam resistant piston within a valve easing,
the jam resistant piston having a section circumscribed by both an exterior surface of the jam resistant piston, and
an interior surface of the valve casing located adjacent to the first exterior surface of the piston;
the exterior surface including a first plurality of grooves circumscribing the jam resistant piston;
a portion of the fluid located between the exterior surface of the jam resistant piston and the interior surface of the valve easing;
wherein axial actuation of the jam resistant piston moves the particulates in the portion of the fluid and sequesters a first portion of the plurality of particulates in the first plurality of grooves in the exterior surface.

2. The valve of claim 1 wherein the valve casing includes an outlet port in the interior surface for delivering the fluid to the jam resistant piston, and
the jam resistant piston includes and first inlet port in the exterior surface for receiving the fluid from the outlet port.
wherein
the first plurality of grooves is separated from the third plurality of grooves by the pass-through charnel, and
the second plurality of grooves is separated from the third plurality of grooves by the pass-through channel.

3. The valve of claim 2 wherein the jam resistant piston includes a diverter channel radially extending to the first inlet port, and axially extending through the section to a discharge port.

4. The valve of claim 2 wherein the exterior surface includes a second plurality of grooves circumscribing the jam resistant piston;
wherein,
axial actuation of the jam resistant piston sequesters a second portion of the particulates in the second plurality of grooves; and
the first plurality of grooves is separated from the second plurality of grooves by the first inlet port.

5. The valve of claim 4 wherein the first inlet port is distant from both the first plurality of grooves and the second plurality of groves.

6. The valve of claim 4 wherein the jam resistant piston further includes
a transverse bore extending from a pass-though inlet port in the exterior surface to a passthrough outlet port in the exterior surface;
a third plurality of grooves circumscribing the jam resistant piston;
wherein
the first plurality of grooves is separated from the third plurality of grooves by the pass-through channel, and
the second plurality of grooves is separated from the third plurality of grooves by the pass-through channel.

7. The valve of claim 6 wherein
the first inlet port is distant from the first, second, and third plurality of grooves;
the pass-though inlet port is distant from the first, second, and third plurality of grooves;
and
the pass-though outlet port is distant from the first, second, and third plurality of grooves.

8. The piston of claim 7 wherein each groove of the first plurality of grooves is parallel to each groove of the second plurality of grooves.

9. The valve of claim 2 further comprising:
an actuator secured to a first end of the jam resistant piston for axially sliding the jam resistant piston through the valve casing;
wherein the discharge port is located at a second end of the jam resistant piston.

10. The valve of claim 9 wherein the actuator is rigidly secured to the valve casing.

11. The valve of claim 1 wherein the plurality of particulates are composed of a material selected from a group consisting of wood fiber, solidified plastic, and dust.

12. The valve of claim 1 wherein the liquid is molten plastic.

13. The valve of claim 1 wherein each of the first plurality of grooves is an annular groove.

14. The valve of claim 1 further comprising an actuator secured to the jam resistant piston for axially sliding the jam resistant piston through the valve casing.

15. A valve for selectively diverting a liquid carrying particulates, the valve comprising:
a jamming resistant piston connected to, and axially slideable through a valve casing;
the jamming resistant piston having:
a first portion circumscribed by a first plurality of grooves; and
a first fluid channel radially extending though a section of the jamming resistant piston to a first fluid port.

16. The valve of claim 15 wherein each groove of the first plurality of grooves fully circumscribes the first portion of the jamming resistant piston.

17. The piston valve of claim 15 wherein the first fluid channel axially extends through the first portion to a discharge port of the jamming resistant piston.

18. The piston valve of claim 17 further comprising the jamming resistant piston having:
a second portion circumscribed by a second plurality of grooves,
wherein the first fluid port is located between the first plurality of grooves and the second plurality of grooves.

19. The piston valve of claim 17 further comprising the jamming resistant piston including:
a third fluid port,
a fourth fluid port, and
a second fluid channel extending perpendicular to the axis of the piston from the third fluid port to the fourth fluid port.

20. The piston valve of claim 19 further comprising the jamming resistant piston having:
a second portion circumscribed by a second plurality of grooves, and
a third portion circumscribed by a third plurality of grooves, wherein the second fluid channel is entirely located entirely between the second portion and the third portion of the jamming resistant piston.
